(19) United States
(12) Patent Application Publication
(10) Pub. No.: US 2012/0326839 A1
(43) Pub. Date: Dec. 27, 2012

(54) ELECTRONIC DEVICE AND PASSWORD INPUT METHOD THEREOF

(75) Inventor: YAO-HONG DU, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/528,839

(22) Filed: Jun. 21, 2012

(30) Foreign Application Priority Data
Jun. 24, 2011 (CN) 201110174350.6

(51) Int. Cl. G06F 7/04; G06F 3/041

(52) U.S. Cl. 340/5.54

(57) ABSTRACT

An electronic device creates a table for mapping a plurality of pressure values corresponding to a plurality of numerical values, and stores the pressure mapping table in a memory. The electronic device detects a touch on a touch panel of the electronic device and detects a value of the pressure of the touch. The electronic device obtains a numerical value corresponding to the detected pressure value in the pressure mapping table. The electronic device generates a password code as a result of user input based on the numerical value.

### BACKGROUND

1. Technical Field

Embodiments of the present disclosure relate to an electronic device, and more particularly to an electronic device and a password input method.

2. Description of Related Art

User passwords protect personal and private information in an electronic device, such as a mobile phone, a personal computer, or a personal digital assistant. A user is required to input a password via a mechanical or a touch-sensitive input unit before being permitted to access secure data stored in the electronic device. There is a danger that the password input may be easily guessed by observing movement of the user's fingers when inputting the password.

Therefore, a password input method implemented in the electronic device is needed to overcome the aforementioned deficiencies and inadequacies.

### BRIEF DESCRIPTION OF THE DRAWINGS

FIG. 1 is a block diagram of one embodiment of an electronic device in accordance with the present disclosure.

FIG. 2 is a schematic diagram of one embodiment of a relation table stored in a memory of the electronic device.

FIG. 3 is a schematic diagram of one embodiment of a grid displayed on the display unit of the electronic device.

FIG. 4 is a flowchart of one embodiment of a password input method of the electronic device in accordance with the present disclosure.

FIG. 5 is a flowchart of another embodiment of a password input method of the electronic device in accordance with the present disclosure.

### DETAILED DESCRIPTION

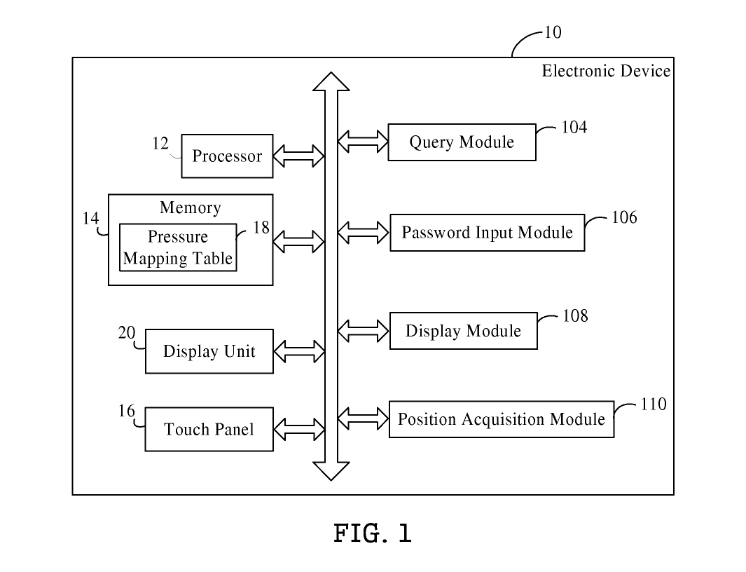

FIG. 1 is a block diagram of one embodiment of an electronic device 10. The electronic device 10 can include a personal computer, a laptop, and a mobile device. A mobile device can include a mobile phone, a smart phone, and a personal digital assistant. In one embodiment, the electronic device 10 includes a processor 12, a memory 14, a touch panel 16, a query module 104, a password input module 106, a display module 108, and a position acquisition module 110. In general, the word “module” refers to logic embodied in hardware or firmware, or a collection of software instructions, written in a programming language. In one embodiment, the programming language may be Java or C language. The modules described herein may be implemented as either software and/or hardware modules and may be stored in the memory 14. One or more software instructions of the modules 104-110 may be executed by the processor 12. The processor 12 controls overall functions of the electronic device 10 and is in communication with the memory 14, the touch panel 16 and the modules 104-110. The processor 12 includes a general-purpose processor, a specialized processor, or a microprocessor that executes software instructions. In one embodiment, the processor 12 operates under control of logic embodied in firmware stored in the memory 14. The memory 14 includes volatile and nonvolatile, removable and non-removable medium implemented in any method or technology for storage of information such as computer-readable instructions, data structures, program modules or other data. The touch panel 16 detects a touch operation by a user, and generates an electrical signal representing a pressure value applied by the touch operation. The touch operation can include a tap or press operation performed on the touch panel 16. In one embodiment, the electronic device 10 can include a display unit 20 using a display surface of the touch panel 16 to display an image provided by the display module 108. The image may include a graphical user interface controlled by the processor 12.

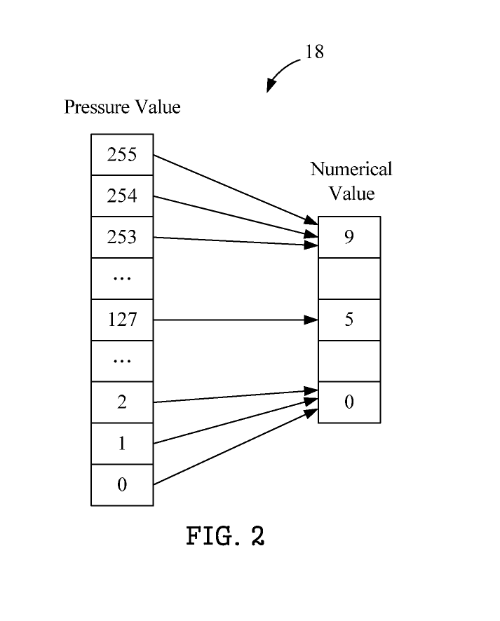

In one embodiment, the memory 14 stores a pressure mapping table 18 that is data that includes a plurality of pressure values and a plurality of corresponding numerical values. The pressure mapping table 18 can be created by the processor 12. FIG. 2 is schematic diagram of one embodiment of the pressure mapping table 18 stored in the memory 14 of the electronic device 10. The pressure mapping table 18 provides mapping between the plurality of pressure values and the plurality of numerical values. Each of the plurality of numerical values is a positive integer. In one embodiment, a specific pressure value between the values of 0 and 255 is mapped to a specific numerical value between the values of 0 and 9 according to the pressure mapping table 18. Referring to FIG. 1, the user can input a password by touching or pressing on the touch panel 16 with his/her finger, or any object like a pencil or stylus. In one embodiment, a pressure value of each touch operation can be detected by the touch paned 16, and a password code is generated according to the detected pressure value. In one embodiment, the display module 108 can display the detected pressure value on the display unit 20 of the electronic device 10. If the user taps the touch panel, the detected pressure value comprises a pressure value and the display module 108 displays the absolute pressure value detected by the touch panel 16. If the user executes a long press (e.g., pressing the touch panel 16 and holding for a predetermined length of time) on the touch panel 16, the detected values comprise time-varying pressure values and the display module 108 displays the time-varying pressure values continuously.

In one embodiment, the display module 108 displays an image adjacent to a touched position on the display unit 20 of the electronic device 10 to represent a touch pressure value of a finger touching the touch position. For example, the display module 108 displays a bubble beside a touched position and the size of the bubble may vary in accordance with the detected pressure value. This allows for password input to be more intuitive as the user can easily associate a touch input with a bubble displayed in connection with a touch pressure value. After a touch operation is finished, the query module 104 obtains a numerical value corresponding to the latest detected pressure value in the pressure mapping table 18. The password input module 106 generates a password code based on the numerical value obtained by the query module 104.

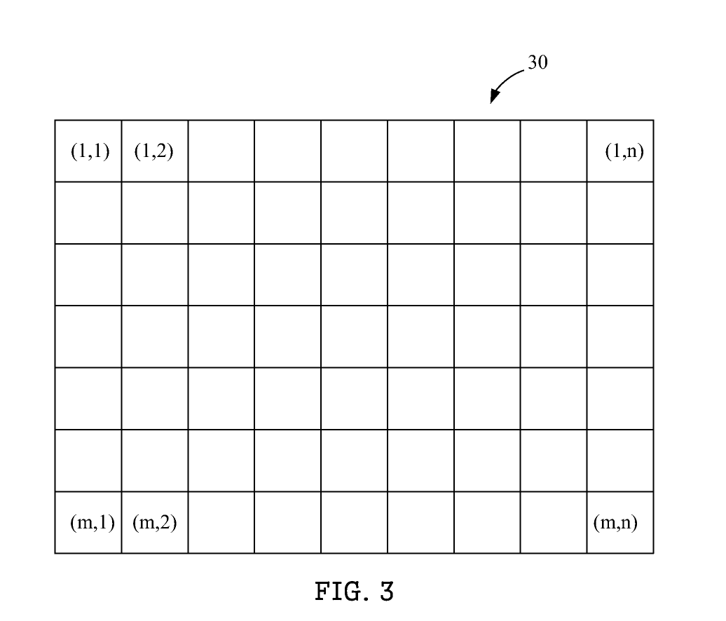

In one embodiment, the touch panel 16 detects a touch operation by a user, and generates an electrical signal representing a pressure value of the touch operation and corresponding information of the touch operation, such as a position of the touch operation on the touch panel 16. The password input module 106 generates password codes utilizing the touched position. For example, the user can position a touch operation on a grid 30 displayed on the display unit 20 by the display module 108. FIG. 3 is a schematic diagram of one embodiment of the grid 30 displayed on the display unit 20 of the electronic device 10. The grid 30 comprises a plurality of squares in rows and columns. In the embodiment shown in FIG. 3, the touch panel 16 is divided in to m rows, n columns, and m*n squares. Each square is positioned as an X-Y coordinate (X, Y) according to a row location index value and a column location index value. The touch panel 16 detects user input as a touch operation. Then, the touch panel 16 outputs information including the square which was touched by the touch operation and a detected pressure value of the touch operation to the position acquisition module 110 and the query module 104 respectively. The position acquisition module 110 establishes an X-coordinate value and a Y-coordinate value in relation to the touched square, and the query module 104 obtains a numerical value corresponding to the detected pressure value in the pressure mapping table 18. The password input module 106 generates a password code based on the X-coordinate value, the

Y-coordinate value and the numerical value. For example, the touch panel 16 may detect that a square located on the third row and the forth column has been pressed by the user with a pressure value of 255, and outputs the position of the touched square and the detected pressure value to the position acquisition module 110 and the query module 104 respectively. The position acquisition module 110 then establishes X-Y coordinates (3, 4) in relation to the touched square, and the query module 104 obtains a numerical value 9 corresponding to the pressure value of 255 in the pressure mapping table 18 as shown in FIG. 2. The password input module 106 generates a password code (as for example 3, 4, 9) according to the user input on the touch panel 16. The grid 30 is scalable and although squares are illustrated in FIG. 3, any appropriate shape can be used, such as for example, but not to be limited to, circles, hexagons, or octagons. The transformation from a touched position to coordinates (X,Y) can vary according to various embodiments.

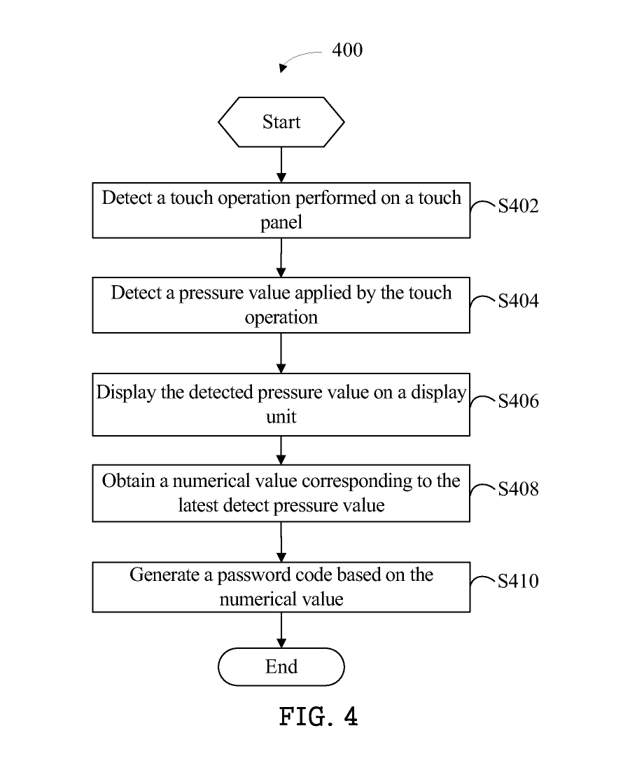

FIG. 4 is a flowchart 400 of one embodiment of a password input method of the electronic device 10. In step S402, the touch panel 16 detects a touch operation on the touch panel 16. In step S404, the touch panel 16 also detects a pressure value of the touch operation and outputs the detected pressure value to the display module 108. In order to make the user aware of the pressure value applied by the touch operation performed on the touch panel 16, in step S406, the display module 108 displays the detected pressure value on the display unit 20 of the electronic device 10. In step S408, the query module 104 obtains a numerical value corresponding to the latest detected pressure value in the pressure mapping table 19. The password input modules 106 generates a password code based on the numerical value obtained by the query module 104 in step S410.

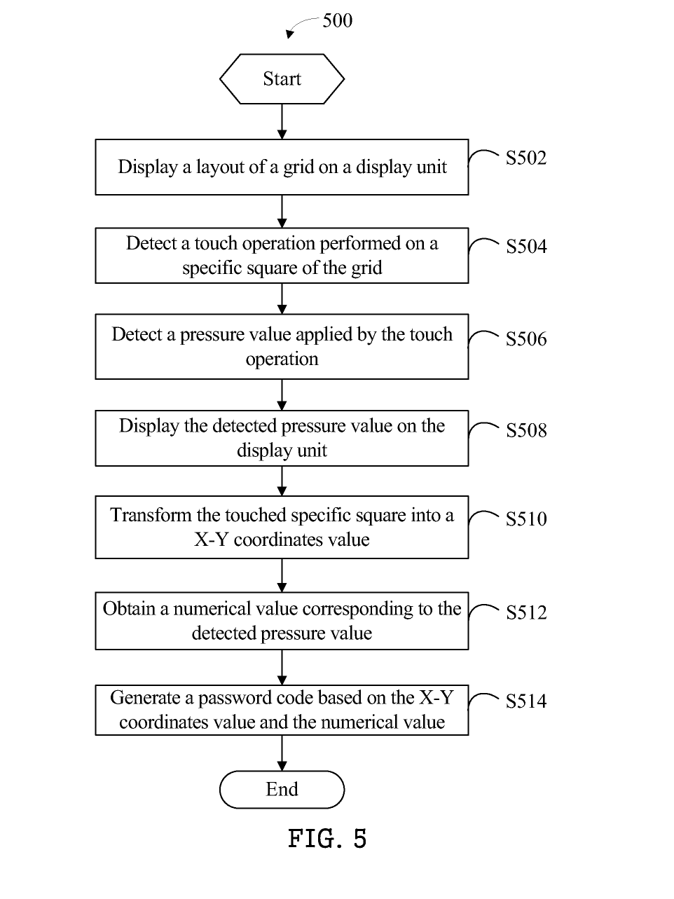

Password codes may be generated from two types of data including the position of touch and the touch pressure. FIG. 5 is a flowchart of another embodiment of a password input method 500 of the electronic device 10 in accordance with the present disclosure. In step S502, the display module 108 displays a layout of the grid 30 on the display unit 20 of the electronic device 10 that divides the touch panel 16 into m rows, n columns, and m*n squares. In step S504, the touch panel 16 detects a touch operation by the user on a specific square of the grid 30. Furthermore, the touch panel 16 detects a pressure value of the touch operation in step S506. In order to make the user aware of the detected pressure value, in step S508, the display module 108 displays the detected pressure value on the display unit 20. In step S510, the position acquisition module 110 equates the touch on a specific square into an X-Y coordinates value. After the user completes the touch, the query module 104 obtains a numerical value corresponding to that latest detected pressure value in the pressure mapping table 18 in step S512. The password input module 106 generates a password code based on the X-Y coordinates value and the numerical value in step S514.

The pressure sensitive password input method in which password codes can be input other than via a keyboard displayed on the touch panel 16 enhances password security.

The foregoing disclosure of various embodiments has been presented for purposes of illustration and description. It is not intended to be exhaustive or to limit the disclosure to the precise forms disclosed. Many variations and modifications of the embodiments described herein will be apparent to one of ordinary skill in the art in light of the above disclosure. The scope of the disclosure is to be defined only by the claims appended hereto and their equivalents.

What is claimed is:

1. An electronic device, comprising:
a touch panel detecting a touch operation on the touch panel and a pressure value applied by the touch operation;
a memory storing a pressure mapping table that maps relationships between a plurality of pressure values of the touch operation and a plurality of numerical values;
an query module obtaining a numerical value corresponding to the pressure value in the pressure mapping table in response to the touch operation; and
a password input module generating a first password code based on the numerical value.

2. The electronic device of claim 1, further comprising:
a display unit; and
a display module displaying the pressure value on the display unit.

3. The electronic device of claim 1, wherein the numerical values are decimal digits.

4. The electronic device of claim 2, wherein the display module further displays a grid on the display unit, wherein the grid comprises a plurality of rows, a plurality of columns, and a plurality of squares formed by the plurality of rows and columns.

5. The electronic device of claim 4, wherein each of the plurality of squares is positioned as an X-coordinate value and an Y-coordinate value according to a row location index value and a column location index value.

6. The electronic device of claim 5, wherein the password input module further generates a second password code based on the X-coordinate value, the Y-coordinate value and the numerical value.

7. A password input method for an electronic device comprising a touch panel and a memory, the method comprising:
detecting a touch operation on the touch panel and a pressure value applied by the touch operation;
storing a pressure mapping table in the memory that maps relationships between a plurality of pressure values of the touch operation and a plurality of numerical values;
obtaining a numerical value corresponding to the pressure value in the pressure mapping table in response to the touch operation; and
generating a first password code based on the numerical value.

8. The method of claim 7, further comprising displaying the pressure value on a display surface of the touch panel.

9. The method of claim 7, wherein the numerical values are a decimal digits.

10. The method of claim 8, further comprising: displaying a grid on the display surface of the touch panel, wherein the grid comprises a plurality of rows, a plurality of columns and a plurality of squares formed by the plurality of rows and columns.

11. The method of claim 10, wherein each of the plurality of squares is positioned as an X-coordinate value and an Y-coordinate value according to a row location index value and a column location index value.

12. The method of claim 11, further comprising generating a second password code based on the X-coordinate value, the Y-coordinate value and the numerical value.
